(19) United States
(12) Patent Application Publication
(10) Pub. No.: US 2002/0068022 A1
(43) Pub. Date: Jun. 6, 2002

(54) Mini-tube rack

(76) Inventor: Jinghua Schneider, Gurnee, IL (US)

Correspondence Address: Paul H. Gallagher, 2530 Crawfore Ave, Evanston, IL, 60201, US

(21) Appl. No.: 09/728,900

(22) Filed: Dec. 4, 2000

(51) Int. Cl. B01L 9/06

(52) U.S. Cl. 422/104

(57) ABSTRACT

A rack for holding mini-tubes for containing materials for testing in a laboratory. It consists entirely of three parts—a body, a bottom plate member and a cover all of transparent plastic material. The body and bottom plate member have vertically aligned holes for receiving and holding the mini-tubes. The cover is placed in the body and is normally held thereon by friction.

### FIELD OF THE INVENTION

The invention resides in the field of utilizing mini-tubes in the laboratory for making tests of materials. For example when liquids are used in laboratory tests, they are placed in mini-tubes. The mini-tubes are held in a rack, in position exposed to the user for placing the liquids therein. After a test is completed, the rack with the mini-tubes is discarded, being put in a common trash receptacle. However, it is desired that the liquids be emptied from the mini-tubes before the rack and mini-tubes are discarded, and the simplest method of so discarding the liquids first, is to invert the rack and thus empty the liquids. Heretofore the mini-tubes would fall out of the rack when the rack was so inverted, which was undesired, because it is then necessary to retrieve the mini-tubes for placing them in the general trash receptacle.

### OBJECTS OF THE PRESENT INVENTION

A main object of the invention is to overcome the foregoing objection.

A more specific object is to provide a new rack for holding the mini-tubes, which grips them and holds them when the rack is inverted, the liquids being safely discarded in a separate receptacle.

A further object is to provide a rack of the foregoing nature, in the use of which, the mini-tubes can be inserted into and removed from the rack in a very simple and easy step.

Still another object is to provide such a rack in the use of which it is extremely simple to remove a single mini-tube from a great number of mini-tubes positioned in close proximity to each other.

A further object is to provide a rack of the foregoing character, which is extremely efficient and easy to use, for storing and transporting the mini-tubes.

### BRIEF DESCRIPTIONS OF THE INDIVIDUAL FIGURES OF THE DRAWINGS

FIG. 1 is a perspective view of the rack of the present invention.

FIG. 2 is a view oriented according to the arrow 2 of FIG. 1 with the parts thereof in exploded position.

FIG. 3 is a view of a mini-tube of the kind accommodated by the rack of the invention.

FIG. 4 is a detailed view taken at line 4-4 of FIG. 2.

FIG. 5 is a view taken at line 5-5 of FIG. 2.

FIG. 6 is a view taken at line 6-6 of FIG. 4.

FIG. 7 is a view taken at line 7-7 of FIG. 6.

FIG. 8 is a view taken at 8-8 of FIG. 7.

FIG. 9 is a view taken at line 9-9 of FIG. 8.

FIG. 10 is a view taken at line 10-10 of FIG. 5.

FIG. 11 is a vertical sectional view of the assembled devices taken at line 11-11 of FIG. 1 and showing a number of the mini-tubes therein.

FIG. 12 is a view of the body of the rack, which is encompassed between the lines 12 of FIG. 11, in inverted position, and holding the mini-tubes therein.

FIG. 13 is a view similar to FIG. 7 but showing positioning of the individual gripper prongs for receiving the mini-tubes.

FIG. 14 is a view similar to FIG. 13 but showing a different arrangement of gripper prongs at the apertures.

FIG. 15 is a view similar to FIGS. 13 and 14 but showing a greater number of apertures in the rack with a maximum number of gripping prongs at each aperture.

FIG. 16 is a view oriented according to FIG. 8 showing another construction, with a ring on the lower end of the gripping prongs.

FIG. 17 is an end view taken at line 17-17 of FIG. 16.

FIG. 18 is a view similar to FIG. 16 but showing three prongs, instead of two.

FIG. 19 is an end view taken at line 19-19 of FIG. 18.

### DETAILED DESCRIPTION OF THE DRAWINGS

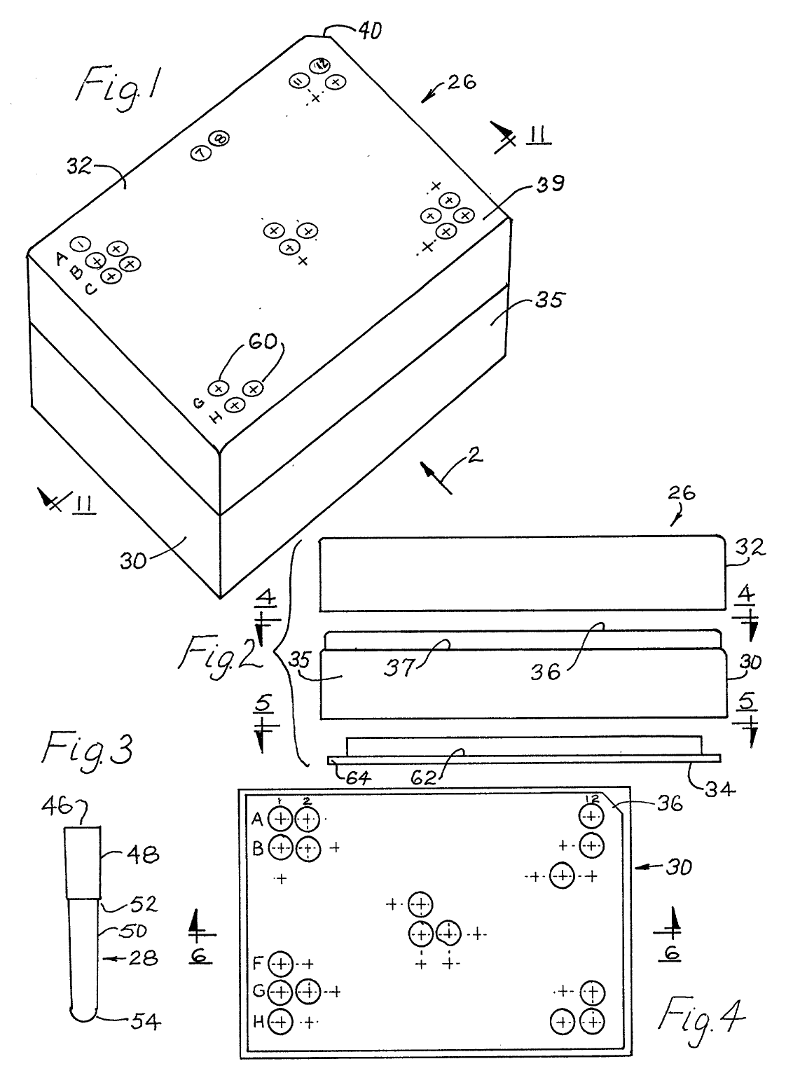

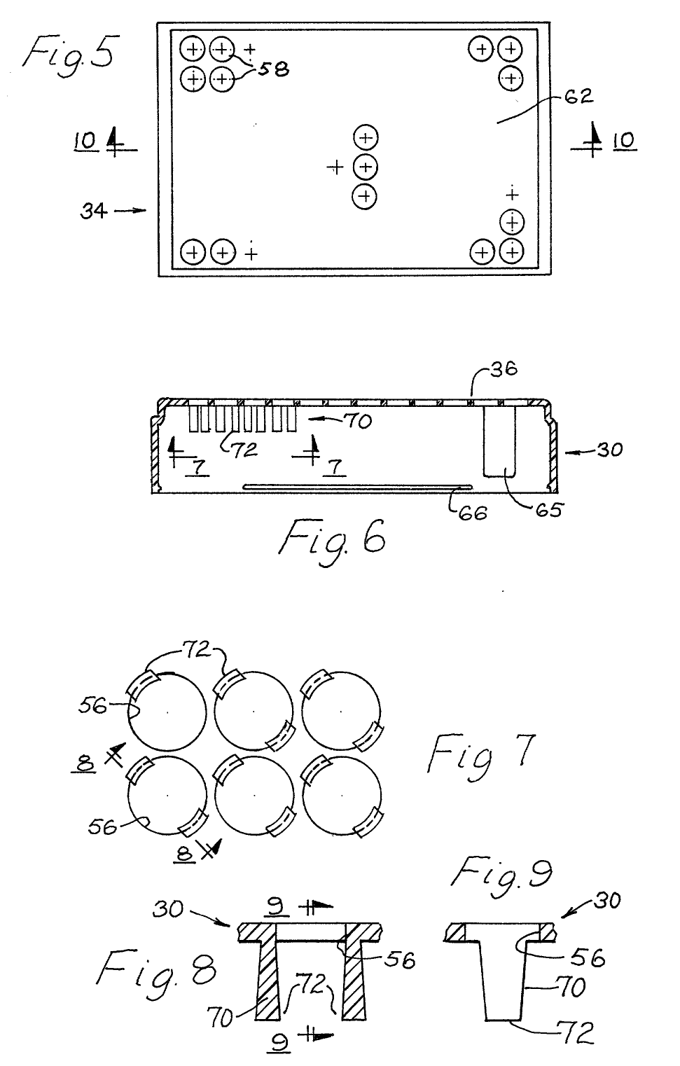

The mini-tube rack is indicated at 26. It is shown in assembled or closed condition in FIG. 1, and in separated and exploded position in FIG. 2.

The mini-tube itself is shown at 28 in FIG. 3, the rack being designed for cooperation with this article, which is a known item.

The rack is made up entirely of three parts, which, as shown in FIG. 2 include a body 30, a cover 32, and a bottom closure plate 34. When the rack is assembled or closed as in FIG. 1, only the body 30 and cover 32 are visible from the side. The bottom closure plate when assembled is positioned entirely in the body and thus not visible from side view. The entire rack and the mini-tubes are made of clear plastic.

The body 30 has a rectangular surrounding vertical wall 35, open at the bottom, and a top element 36 nearly rectangular and of slightly less transverse dimensions than the surrounding wall, forming a ledge or shoulder 37. At one corner the top element 36 has a diagonal element 38 (FIG. 4) for orienting the cover 32 with the body. Further details of the body are described below.

The cover includes a top element 39 and a surrounding skirt 40. The skirt is uniform in vertical direction, and when the cover is applied to the body, the lower edge of the skirt fits on the top element 36 and engages the ledge 37 as shown in section in FIG. 11. Thus the vertical surfaces of the cover and body lie in a common envelope, having common vertical sidewalls, except for a diagonal cut-off 40 which fits on the corresponding shape 36 on the body (FIG. 4), to provide fitting together of these two parts in only a single position.

The mini-tube 28 (FIG. 3) as noted above is a presently known item, has an open top 46 and is tapered generally downwardly. It is made up of two main sections, an upper section 48, and a lower section 50 slightly smaller than the upper section, thereby forming a shoulder 52 of a width similar of the thickness of the wall of the cover. The lower section 50 continues in a general tapered shape and has a rounded closed bottom 54. The shoulder 52 is utilized in limiting the insertion of the mini-tube into the rack as referred to again hereinbelow.

The body 30 and bottom closure plate 34 (FIG. 11) form a sub-unit in which the mini-tubes are mounted and held. The cover 32 is applied for transporting and storing the mini-tubes, and when the rack is to be used for testing purposes, the cover is removed. The body and bottom closure plate are provided with holes or apertures 56 and 58.

The cover 32 has markings 60 in the top element identifying the holes in the body and bottom closure plate, and the markings in the cover are all aligned vertically with those holes, and arranged in rows and tiers. FIG. 4 best shows this arrangement, which includes eight rows identified by the latters A-H, and twelve tiers identified by the numerals 1-12. A device approximately 5″ long, 3 ¼″ wide, and 2″ deep has proved practical. The mini-tube is approximately ⅜″ in diameter at its top, and approximately ¼″ in diameter at the bottom of its main taper, at point 60. It is approximately 1 ⅞″ in total length. These dimensions, and numbers, are examples, and the invention is not limited to such dimensions.

The mini-tubes are inserted into the holes 56 in the body (FIG. 11), and the shoulders 52 engage the top surtace 36 of the body and are limited in further extension.

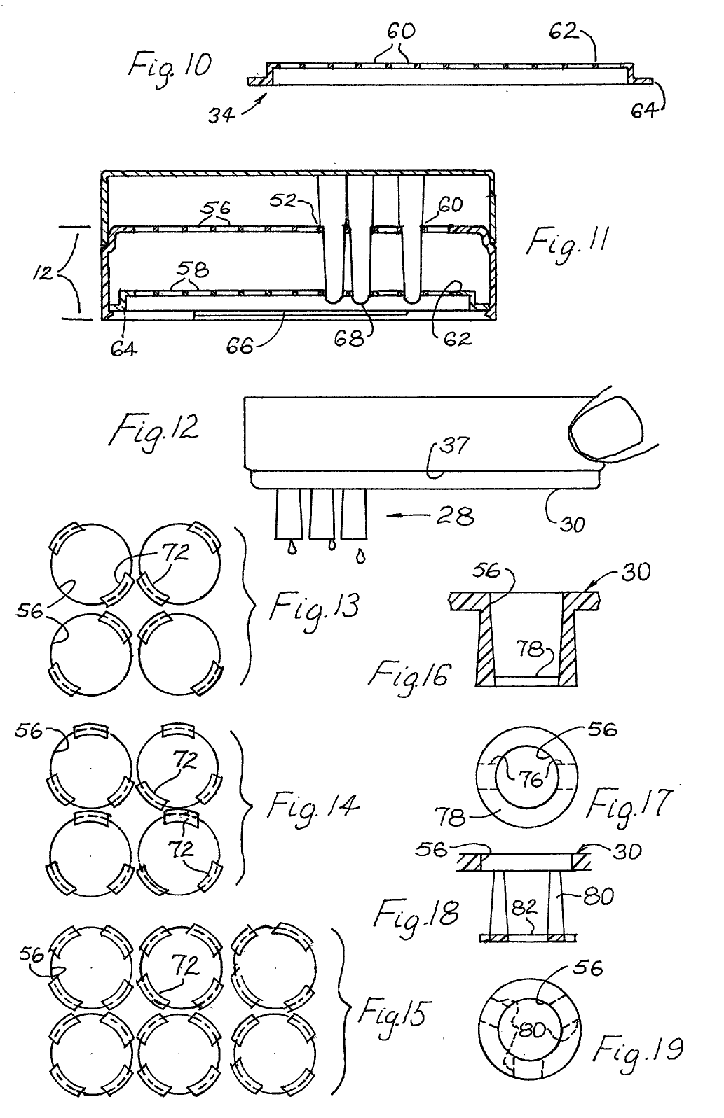

The bottom closure plate has a top element 62 (FIGS. 5, 10, 11) in which the holes 58 are formed.

The bottom closure plate 34 is of smaller dimensions than the surrounding skirt of the body (FIG. 11) and at its bottom is provided with a surrounding, out-turned flange 64. The bottom closure plate is snap-fitted in the open bottom of the body, and snapped over ribs 66 (FIGS. 6, 11) and are thereby normally securely hold in the body, but it may be removed by prying it out of that position with a small tool.

Lugs 65 (FIG. 6) form stops for preventing the bottom closure plate from being pushed too far into the body.

When the mini-tubes are fitted in the body they extend through the bottom closure plate a small extent as indicated at 68 in FIG. 11, but do not extend down to the lower edge of the body. Therefore when a filled rack is placed on a flat surface, only the surrounding wall of the body will engage that surface. To remove the mini-tubes from the body, they may be engaged at the bottom by the finger (FIG. 11), and pushed upwardly a slight amount, so that their upper ends can be grasped by the fingers.

The body is provided with gripping prongs or fingers, identified generically at 70 in FIG. 6. These prongs are integral with the top element of the body, and are flexible transversely at their free ends. The mini-tubes upon being inserted through the apertures in the body, are engaged at the sides by these prongs, which frictionally grip them and prevent them from falling out when the body is inverted. These prongs may have gripper elements 72 (FIGS. 5, 9) for providing additional friction gripping with the mini-tubes.

In the case of the body 30 bottom closure plate 34, the letters and the numerals are embossed on the upper surface of the top element of the body. However, in the case of the cover, apertures are not provided, but the identifying markings are in the form of circles in the form of embossments on the underside of the top element of the cover. Similarly the letters are embossed on that surface. These circles are in vertical alignment with the apertures in the body and bottom closure plate as noted. It will be understood that the cover is friction fitted on the body, and in normal use, these two parts are frictionally held together, although they may be easily separated by applying extra pressure by the fingers.

The rack, when loaded with mini-tubes filled with liquid, may be stored or transported, with the cover applied to the body. In the use of the rack in the laboratory, the rack is placed on a table and the cover removed, and the mini-tubes are thus exposed for independent use. The entire device, with the mini-tubes, may be considered expendable, and after its use in a laboratory, it is therefore merely discarded in the trash. In the general use in the laboratory, it is customary to throw out the liquids before discarding the entire device. Heretofore, a great problem existed, in that when it was attempted to invert the device (FIG. 12) to dispose of the liquid, the mini-tubes would fall out. In the use of the present device, the mini-tubes are securely gripped in position and do not fall out upon such inversion of the device while only the liquid is emptied.

In the use of the rack, when it is desired to remove individual mini-tubes from a rack, this step is facilitated by having the lower ends of the mini-tubes extend through the bottom closure plate. This arrangement, referred to above and shown in FIG. 11, enables the user to merely apply the finger to the bottom end of a single mini-tube, when it is in the body, with the cover removed, and this pushes it up above the level of the remaining mini-tubes, whereby the user can merely grip the upper end of that particular mini-tube and lift it out of the body.

Reference now is again made to the prongs or fingers 70 (FIG. 6). These prongs are also shown in FIGS. 7-9. FIG. 7 shows the top element of the body in which the apertures 56 are formed. This figure shows a longitudinal axis 72 and a transverse axis 74, representing the rows and tiers of the holes. The prongs 70 are disposed on an axis at an oblique angle to the axis 72 so as to prevent interference between the prongs of adjacent holes.

FIG. 13 shows another arrangement of the positioning of the prongs. In this case the prongs on four adjacent holes may be positioned around a common center 76, leaving space between the adjacent prongs.

FIG. 14 shows an arrangement in which each hole is provided with three prongs. In this case, the prongs, relative to adjacent holes, are staggered, or out of mesh. This arrangement provides sufficient space between the adjacent elements, with the further advantage that three prongs may be desired for greater gripping effect.

FIG. 15 shows an arrangement including four prongs at each hole. This arrangement is similar to that of FIG. 13, in the sense that respective ones of the prongs in four adjacent holes are arranged around a central point 76, while oppositely located prongs 79 are disposed around other centers.

The prongs 70 as noted, are free at their extended ends. It is also contemplated within the scope of the invention to provide a ring at the extended ends of the prongs to provide greater gripping effect. This arrangement in shown in FIGS. 16-19. In FIGS. 16 and 17, two such prongs 76, at a single hole, are provided with an integral ring 78. The ring yields a small amount to enable the mini-tube to be pushed therethrough.

FIGS. 18-19 show constructions essentially similar to that of FIGS. 16, 17, but includes three prongs 80 and a ring 82. It is practical also to provide four prongs instead of two or three, if so desired.

1. A test tube rack adapted for holding a plurality of test tubes, comprising,
a casing,
the casing including a body, a bottom plate member, and a cover,
the body including a flat top element and a surrounding depending skirt forming an open bottom, the bottom plate member including a flat element and being detachably snap-fitted in the open bottom of the body,
the flat top element of the body and said flat element of the bottom plate having holes therethrough respectively aligned in a common pattern,
the test tubes being adapted for being fitted in aligned holes in said flat top element and the bottom plate member, and when so fitted being frictionally held in that position, and extending above said flat top element and below said bottom plate member, and,
the cover being adapted to be detachably fitted to the body in enclosing relation to the test tubes.

2. A test tube rack according to claim 1, wherein,
the body includes prongs on the lower surface of the flat top element at the marginal edges for each hole in the flat element,
the prongs being flexible for yieldably holding the test tube in position.

3. A test tube rack according to claim 2 wherein,
the prongs at each hole, in any selected one of the racks being one of 2 or 3 or 4 in number.

4. A test tube rack according to claim 3, and including,
a ring interconnecting the lower ends of the prongs of each hole, and being yieldable for receiving the corresponding tube therethrough, and elastic to maintain sufficient pressure on the test tube to normally retain it in position in the hole.

5.A test tube rack according to claim 2 wherein,
the pattern of holes including line of relatively longitudinal and transverse holes arranged at right angles, and
the prongs being arranged diagonally relative to said longitudinal and transverse holes.

6. A test tube rack according to claim 4 wherein,
the cover includes visible indicia identifying the individual holes, when the cover is fitted to the body.

7. A test tube rack according to claim 6 wherein,
said indicia are formed by embossments on the inner surface of the cover.

8. A test tube according to claim 7 wherein,
the body has indicia thereon, identifying at least certain of the holes, and
the body and cover having outlines shapes such as to enable them to be fitted together in only a single position relative to each other for establishing correlation between the indicia on the body and cover.
